(19) United States
(12) Patent Application Publication
(10) Pub. No.: US 2013/0147740 A1
(43) Pub. Date: Jun. 13, 2013

(54) TOUCH DISPLAY DEVICE

(71) Applicant: Wintek Corporation, Taichung City (TW)

(72) Inventors: Chih-Yuan Wang, Taichung City (TW); Ching-Fu Hsu, Taichung City (TW); Cheng-Yi Chou, Yunlin County (TW); Yu-Hua Wu, Taoyuan County (TW); Chang-Hsuan Hsu, Changhua County (TW); Ting-Yu Chang, Kaohsiung City (TW); Kuan-Hsien Wu, Changhua County (TW); Fa-Chen Wu, Taichung City (TW)

(73) Assignee: WINTEK CORPORATION, Taichung City (TW)

(21) Appl. No.: 13/711,638

(22) Filed: Dec. 12, 2012

(30) Foreign Application Priority Data
Dec. 12, 2011 (TW) 100145850

(51) Int. Cl. G06F 3/041

(52) U.S. Cl. CPC G06F 3/041
USPC 345/173

(57) ABSTRACT

A touch display device includes a display panel, a touch panel, and a non-self-luminescent display panel. The display panel includes at least one luminescent unit for generating a display image. The touch panel is disposed correspondingly to the display panel. The non-self-luminescent display panel is disposed between the touch panel and the display panel. The non-self-luminescent display panel includes a display medium layer for generating a non-self-luminescent display image or for being transparent to let the display image from the display panel pass through the display medium layer.

### BACKGROUND OF THE INVENTION

1. Field of the Invention

The present invention relates to a touch display device, and more particularly, to a touch display device including a non-self-luminescent display panel disposed on a display panel.

2. Description of the Prior Art

In non-self-luminescent display devices, ambient light, instead of light from a backlight module, is employed to generate a non-self-luminescent display image and purposes of thinner designs and low power consumption may be achieved without backlight module. Consumer electronics, such as electronic papers and tablet PCs are employed with non-self-luminescent display devices. However, the display performances of the non-self-luminescent display device will be seriously influenced by the ambient light, and the adequate using situations are accordingly limited. In addition, touch sensing technologies have developed flourishingly in recent years, and electronic products, which have both the touch sensing function and the display function, are commercialized accordingly. Therefore, related industries still work on integrating the functions and structures of the touch panel and the display panel more effectively.

### SUMMARY OF THE INVENTION

It is one of the objectives of the present invention to provide a touch display device. A non-self-luminescent display panel is disposed between a touch panel and a display panel. A normal display mode and a non-self-luminescent display mode may be accordingly switchable in the touch display device, and the usability of the touch display device may then be enhanced.

To achieve the purposes described above, a preferred embodiment of the present invention provides a touch display device. The touch display device includes a display panel, a touch panel, and a non-self-luminescent display panel. The display panel includes a lower substrate and at least one luminescent unit disposed on the lower substrate for generating a display image. The touch panel is disposed correspondingly to the display panel. The non-self-luminescent display panel is disposed between the touch panel and the display panel. The non-self-luminescent display panel includes a display medium layer for generating a non-self-luminescent display image or for being transparent to let the display image from the display panel pass through the display medium layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch display device according to a first preferred embodiment of the present invention.

FIG. 2 is a schematic diagram illustrating a touch display device according to another exemplary embodiment of the present invention.

FIG. 3 is a schematic diagram illustrating a touch display device according to a second preferred embodiment of the present invention.

FIG. 4 is a schematic diagram illustrating a touch display device according to a third preferred embodiment of the present invention.

FIG. 5 is a top-view diagram illustrating a top touch electrode according to the third preferred embodiment of the present invention.

FIG. 6 is a top-view diagram illustrating a top touch electrode according to another exemplary embodiment of the present invention.

FIG. 7 is a schematic diagram illustrating a touch display device according to a fourth preferred embodiment of the present invention.

FIG. 8 is a schematic diagram illustrating a touch display device according to a fifth preferred embodiment of the present invention.

FIG. 9 is a top-view diagram illustrating a top touch electrode according to the fifth preferred embodiment of the present invention.

FIG. 10 is a schematic diagram illustrating a touch display device according to a sixth preferred embodiment of the present invention.

FIG. 11 is a schematic diagram illustrating a touch display device according to a seventh preferred embodiment of the present invention.

FIG. 12 is a top-view diagram illustrating a top touch electrode according to the seventh preferred embodiment of the present invention.

FIG. 13 is a schematic diagram illustrating a touch display device according to an eighth preferred embodiment of the present invention.

FIG. 14 is a schematic diagram illustrating a touch display device according to a ninth preferred embodiment of the present invention.

FIG. 15 is a schematic diagram illustrating a touch display device according to a tenth preferred embodiment of the present invention.

FIG. 16 is a schematic diagram illustrating a touch display device according to an eleventh preferred embodiment of the present invention.

FIG. 17 is a schematic diagram illustrating a touch display device according to a twelfth preferred embodiment of the present invention.

### DETAILED DESCRIPTION

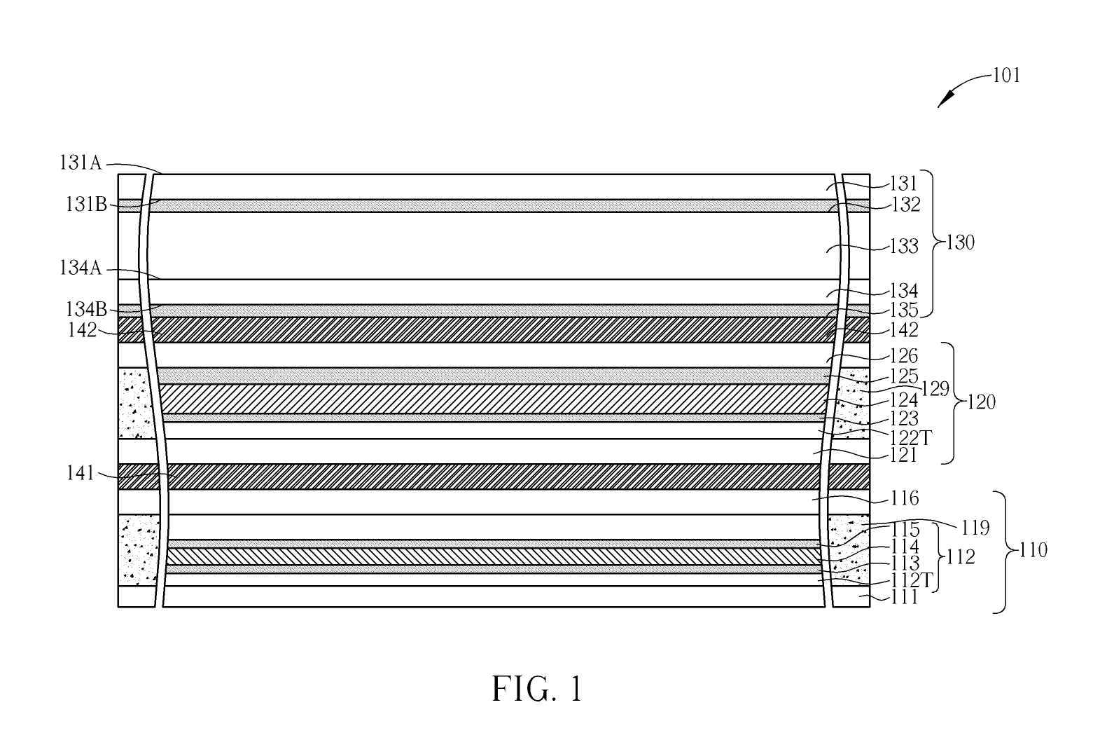

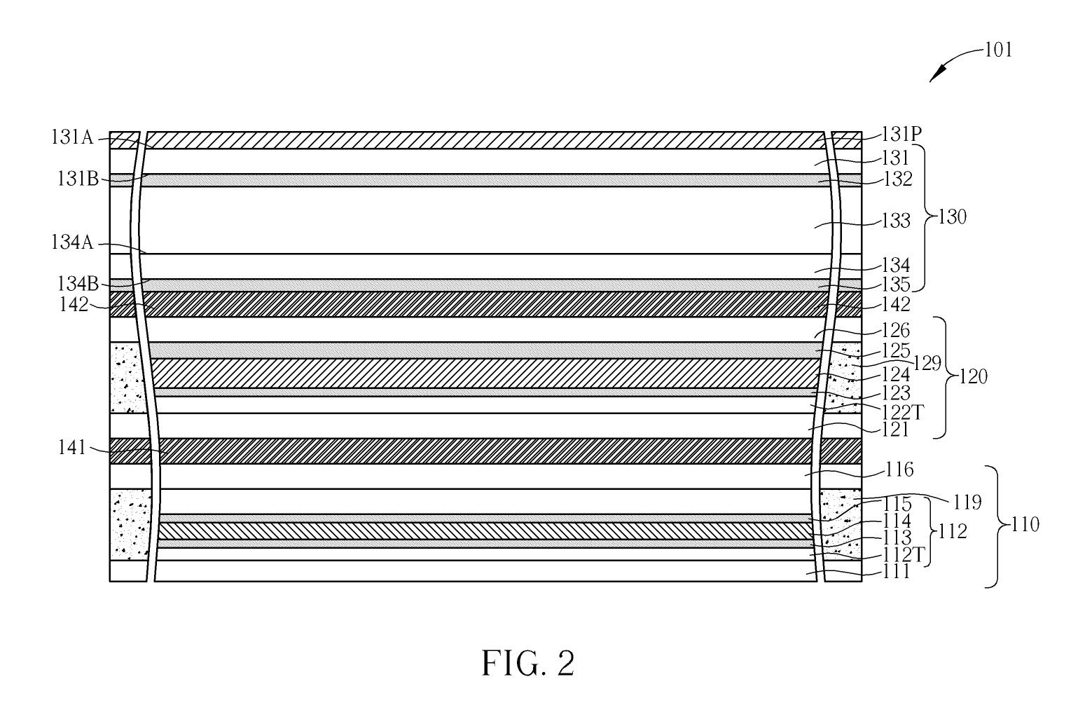

Please refer to FIG. 1 and FIG. 2. FIG. 1 is a schematic diagram illustrating a touch display device according to a first preferred embodiment of the present invention. FIG. 2 is a schematic diagram illustrating a touch display device according to another exemplary embodiment of the present invention. Please note that the figures are only for illustration and the figures may not be to scale. The scale may be further modified according to different design considerations.

As shown in FIG. 1, the first preferred embodiment of the present invention provides a touch display device 101. The touch display device 101 includes a display panel 110, a touch panel 130, and a non-self-luminescent display panel 120. The display panel 110 includes a lower substrate 111, a cover substrate 116, and a luminescent unit 112. The cover substrate 116 is disposed correspondingly to the lower substrate 111, and the luminescent unit 112 is disposed on the lower substrate 111. The luminescent unit 112 is employed to generate a display image. The touch panel 130 is disposed correspondingly to the display panel 110. The non-self-luminescent display panel 120 is disposed between the touch panel 130 and the display panel 110. The non-self-luminescent display panel 120 includes a display medium layer 124. The display medium layer 124 is employed to generate a non-self-luminescent display image or to be transparent for letting the display image from the display panel 110 pass through the display medium layer 124. In other words, under a non-self-luminescent display mode, the display panel 110 may be turned off and the non-self-luminescent display panel 120 may be employed to generate a non-self-luminescent display effect for lowering the power consumption of the touch display device 101. In addition, under a normal display mode of the touch display device 101, the non-self-luminescent display panel 120 may become transparent and let the display image from the display panel 110 pass through the display medium layer 124 for displaying a self-luminescent display effect. The using situations of the touch display device 101 may therefore become more flexible. Purposes of multiple using situations and low power consumption may be achieved because the normal display mode and the non-self-luminescent display mode may be switchable in the touch display device 101.

The display panel 110 in this embodiment may preferably include a self-luminescent display panel such as an organic light emitting diode (OLED) display panel or other appropriate display panels, and the luminescent unit 112 may preferably include an organic light emitting diode unit, but not limited thereto. For example, the display panel 110 may be a liquid crystal display panel, and the luminescent unit 112 may be used to provide a backlight source. In the display panel 110 of this embodiment, the luminescent unit 112 is disposed between the lower substrate 111 and the cover substrate 116, and the luminescent unit 112 may include a first controlling unit 112T, a first electrode 113, a light emitting layer 114, and a second electrode 115. The first electrode 113 is electrically connected to the first controlling unit 112T. The second electrode 115 is disposed correspondingly to the first electrode 113, and the light emitting layer 114 is disposed between the first electrode 113 and the second electrode 115. It is worth noting that, the amount of the luminescent units 112 may be increased and the component of the light emitting layer 114 may be modified in the touch display device 101 in order to present different display effects. Additionally, the luminescent unit 112 may preferably include a top emission OLED unit, but not limited thereto.

As shown in FIG. 1, the non-self-luminescent display panel 120 further includes an array substrate 121, a second controlling unit 122T, a third electrode 123, a fourth electrode 125, and an upper substrate 126. The upper substrate 126 is disposed correspondingly to the array substrate 121. The second controlling unit 122T is disposed on the array substrate 121, and the second controlling unit 122T is electrically connected to the third electrode 123. The fourth electrode 125 is disposed correspondingly to the third electrode 123, and the display medium layer 124 is disposed between the third electrode 123 and the fourth electrode 125. By controlling an electrical condition between the third electrode 123 and the fourth electrode 125, the display medium layer 124 may generate a non-self-luminescent display effect such as a reflective display effect or a transmissive display effect, and the display medium layer 124 may become transparent and let the display image from the display panel 110 pass through the display medium layer 124. The reflective display effect and the transmissive display effect mentioned above may be a display effect generated from the ambient light, but not limited thereto. In other words, the third electrode 123 and the second controlling unit 122T are preferably disposed between the cover substrate 116 and the display medium layer 124, but not limited thereto. It is worth noting that the display medium layer 124 may preferably include a cholesteric liquid crystal, a polymer dispersed liquid crystal (PDLC), a polymer network liquid crystal (PNLC), an electronic ink, a quick response liquid powder, or other appropriate display medium materials capable of generating a non-self-luminescent display effect, such as the reflective display effect or the transmissive display effect, and becoming transparent for letting the display image from the display panel 110 pass through the display medium layer 124. In the non-self-luminescent display panel 120 of this embodiment, the amounts of the third electrode 123, the fourth electrode 125, and the display medium layer may be increased and the component of the display medium layer 124 may be modified to provide different display images. In addition, the second controlling unit 122T and the first controlling unit mentioned above may respectively include an amorphous silicon thin film transistor (a-Si TFT), a poly silicon thin film transistor (poly-SI TFT), or an oxide semiconductor thin film transistor, but the present invention is not limited to this and other appropriate controlling units may also be employed.

In this embodiment, the touch panel 130 may preferably include a force sensing touch panel, but not limited to this. As shown in FIG. 1, the touch panel 130 of this embodiment includes an upper touch substrate 131, a lower touch substrate 134, a top touch electrode 132, a bottom touch electrode 135, and a spacing material layer 133. The lower touch substrate 134 is disposed correspondingly to the upper touch substrate 131. A lower surface 131B of the upper touch substrate 131 faces an upper surface 134A of the lower touch substrate 134, and an upper surface 131A of the upper touch substrate 131 faces toward a direction opposite to a lower surface 134B of the lower touch substrate 134. The top touch electrode 132 is disposed between the upper touch substrate 131 and the lower touch substrate 134. More specifically, the top touch electrode 132 is disposed on the lower surface 131B of the upper touch substrate 131. The spacing material layer 133 is disposed between the upper touch substrate 131 and the lower touch substrate 134. The bottom touch electrode 135 is disposed correspondingly to the top touch electrode 132, and the bottom touch electrode 135 is disposed on the lower surface 134B of the lower touch substrate 134. In other words, the lower touch substrate 134 in this embodiment is disposed between the bottom touch electrode 135 and the spacing material layer 133. It is worth noting that conductive objects such as a human finger and non-conductive objects such as a touch stylus may be suitable to touch the touch panel 130 of this embodiment. Coupled capacitance may be formed between the top touch electrode 132 and a conductive object that touches the touch panel 130, and variations of the electrical properties may be used to position the touch point. Additionally, when a non-conductive object is applied to touch the touch panel 130, the spacing material layer 133 around the touch point may be deformed by pressing, the distance between the top touch electrode 132 and the bottom touch electrode 135 may be changed, and the capacitance between the top touch electrode 132 and the bottom touch electrode 135 may be accordingly changed. The variations of the electrical properties may be used to position the touch point, and a force sensing touch effect may then be obtained. The spacing material layer 133 in this embodiment may be a transparent spacing material layer, but not limited thereto. The spacing material layer 133 may preferably include a solid spacing material a liquid spacing material, or a gaseous spacing material, but not limited thereto. The solid spacing material mentioned above may include an acrylic solid material, an epoxy solid material, a silicon solid sealant, and a flexible plastic material. The liquid spacing material mentioned above may include an acrylic liquid material, an epoxy liquid material, a silicon liquid sealant, a monomer, an oligomer, a liquid crystal, silicone oil, water, or other liquid stuffing. The gaseous spacing material mentioned above may include air, nitrogen, helium, argon, or other inactive gas.

In addition, as shown in FIG. 1, the touch display device 101 of this embodiment further includes a first adhesive layer 141 and a second adhesive layer 142. The first adhesive layer 141 is disposed between the display panel 110 and the non-self-luminescent display panel 120, and the first adhesive layer 141 is employed to combine the display panel 110 with the non-self-luminescent display panel 120. The second adhesive layer 142 is disposed between the non-self-luminescent display panel 120 and the touch panel 130, and the second adhesive layer 142 is employed to combine the non-self-luminescent display panel 120 with the touch panel 130. The display panel 110 may further include a dam 119 disposed between the lower substrate 111 and the cover substrate 116, and the dam 119 is employed to surround luminescent unit 112. Additionally, the non-self-luminescent display panel 120 may further include a sealant material 112 disposed between the array substrate 121 and the upper substrate 126. The sealant material 129 is employed to combine the array substrate 121 and the upper substrate 126, and the display medium layer 124 may accordingly be fixed between the array substrate 121 and the upper substrate 126. In the touch display device 101 of this embodiment, the upper touch substrate 131, the lower touch substrate 134, the upper substrate 126, the array substrate 121, and the cover substrate 116 may respectively include a transparent plastic substrate or a transparent glass substrate. The top touch electrode 132, the bottom touch electrode 135, the third electrode 123, and the fourth electrode 125 may include transparent conductive materials for enhancing a transmittance of the touch display device 101. The transparent conductive materials mentioned above may preferably include inorganic conductive materials, metal conductive materials, oxide conductive materials, carbon nanotubes (CNT) conductive materials, nanowires conductive materials, nanoparticles conductive materials, polymer conductive materials, metal-polymer conductive composites, carbon-polymer conductive composites, or inorganic-polymer conductive composites, but not limited thereto.

In addition, the upper touch substrate 131 of the touch panel 130 in this embodiment may preferably include a polarizer substrate, but not limited thereto. For example, as shown in FIG. 2, in another exemplary embodiment of the present invention, the touch display device 101 may further include a polarizer 131P, disposed on the touch panel 130. The above-mentioned polarizer substrate and the polarizer 131P may be a linear polarizer or a circular polarizer, and the influence of the ambient light on the display quality of the display panel 110 may be accordingly reduced. When the upper touch substrate 131 is a polarizer substrate or a polarizer 131P is disposed on the touch panel 130, the display medium layer 124 of the non-self-luminescent display panel 120 may preferably include a positive nematic liquid crystal or a negative nematic liquid crystal. By combining the features described above and other polarizing optical designs, the non-self-luminescent display panel 120 may then generate the reflective display effect or the transmissive display effect and become transparent for letting the display image from the display panel 110 pass through the display medium layer 124. The related polarizing optical designs may be referred to U.S. patent application Ser. No. 11/393,777, U.S. patent application Ser. No. 11/543,837, U.S. patent application Ser. No. 11/975,595, U.S. patent application Ser. No. 11/896,629, U.S. patent application Ser. No. 11/898,822, and Taiwan Patent Application No. 093210601, and will not be described here.

The following description is based on different embodiments of the touch display device in the present invention. To simplify the description, the following description will focus on the differences among embodiments rather than similar parts. Furthermore, the same reference numbers are used in each description of embodiments for the convenience of cross-reference.

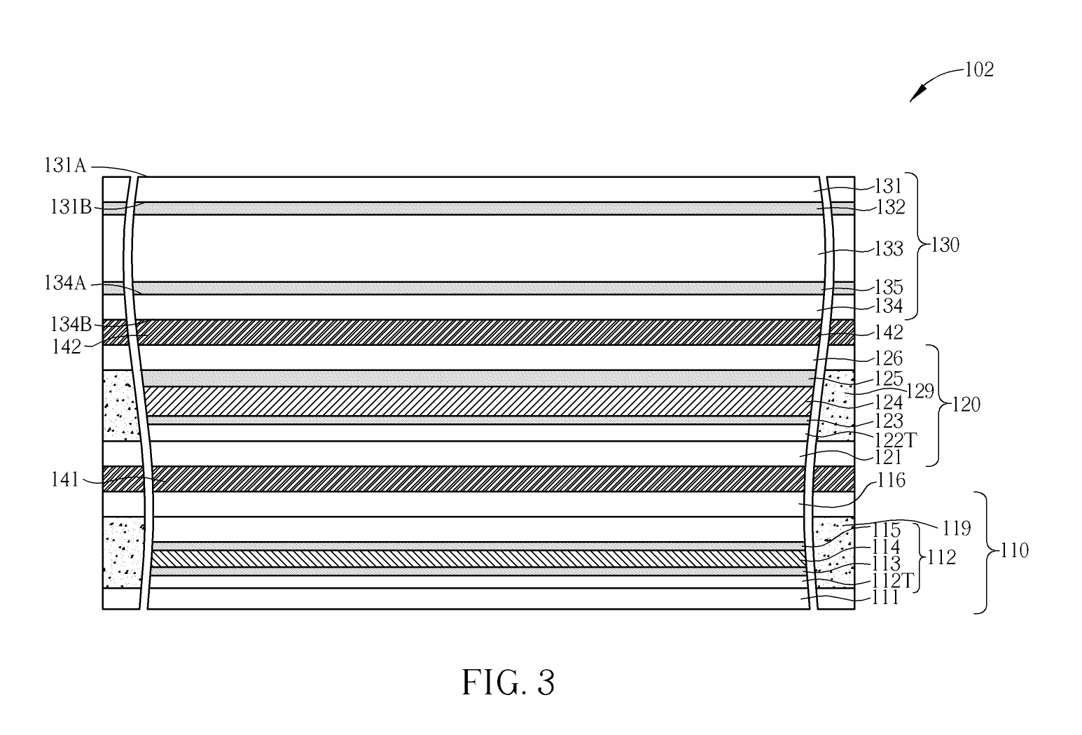

Please refer to FIG. 3. FIG. 3 is a schematic diagram illustrating a touch display device 102 according to a second preferred embodiment of the present invention. As shown in FIG. 3, the difference between the touch display device 102 of this embodiment and the touch display device 101 of the first preferred embodiment is that the bottom touch electrode 135 in this embodiment is disposed between the lower touch substrate 134 and the spacing material layer 133. More specifically, the bottom touch electrode 135 in this embodiment is disposed on the upper surface 134A of the lower touch substrate 134, the distance between the top touch electrode 131 and the bottom touch electrode 135 may accordingly reduced, and the sensing performances of the force sensing operation may therefore be enhanced. Apart from the allocation of the bottom touch electrode 135 in this embodiment, the other components, allocations and material properties of this embodiment are similar to those of the first preferred embodiment detailed above and will not be redundantly described. It is worth noting that the touch panel 130 of this embodiment may also be driven by a resistance type touch sensing approach and become a resistance type force sensing touch panel because the bottom touch electrode 135 and the top touch electrode 132 are both disposed between the upper touch substrate 131 and the lower touch substrate 134.

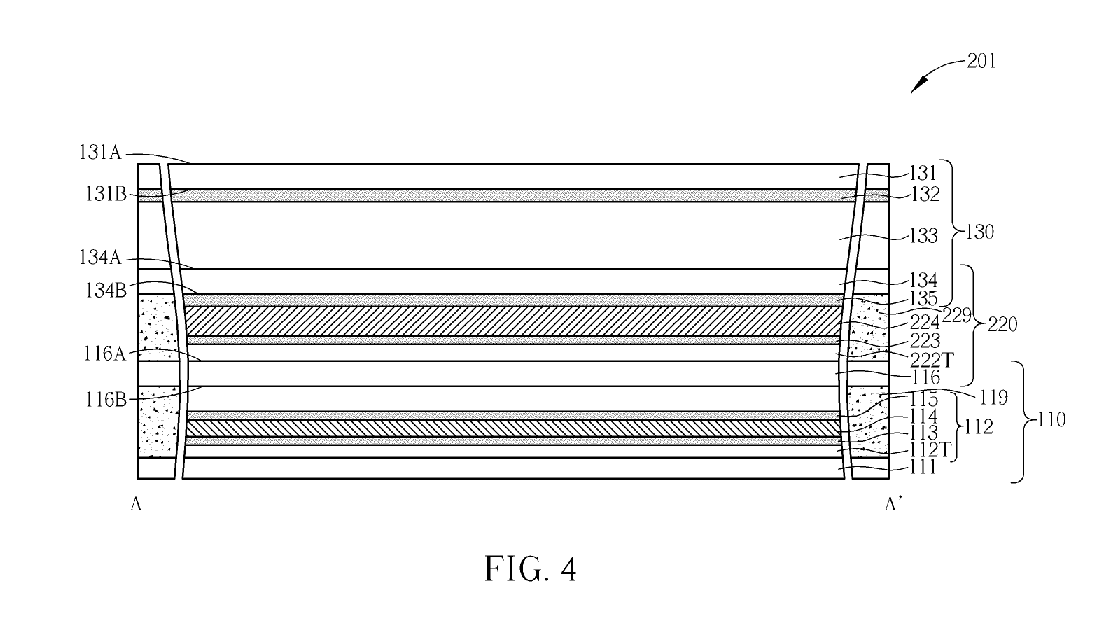

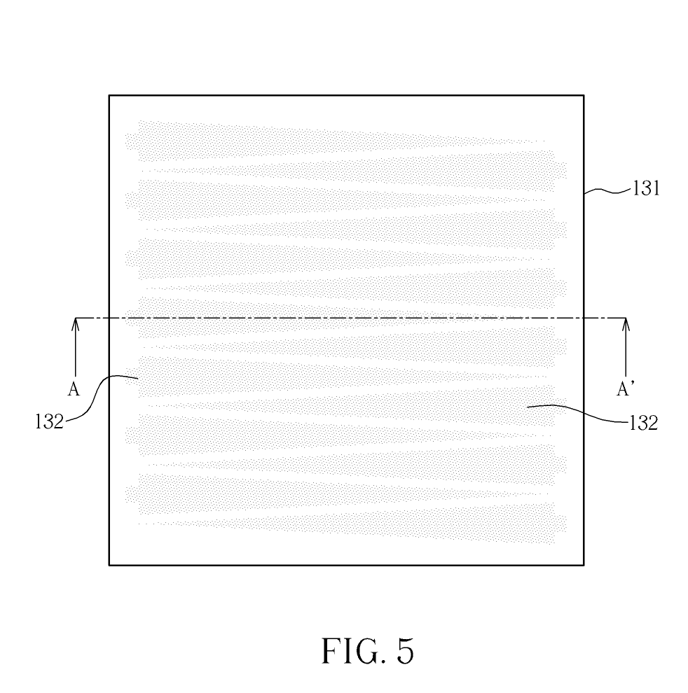

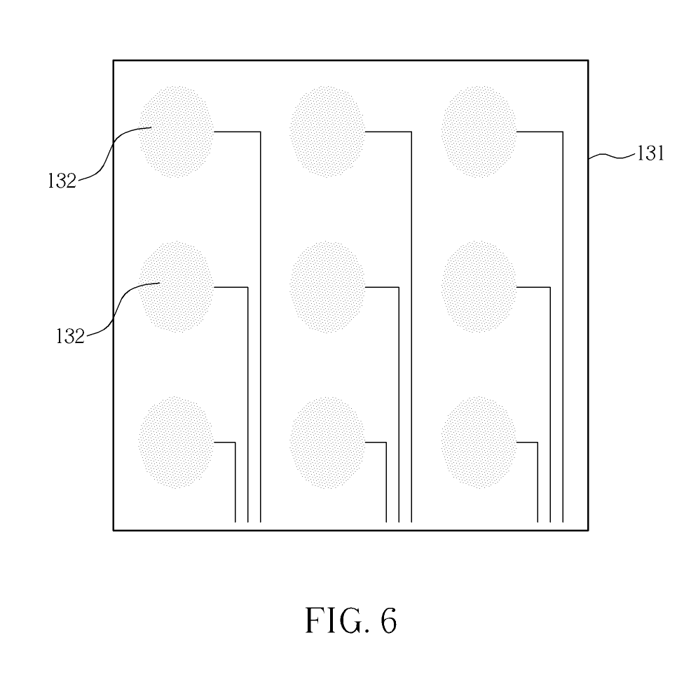

Please refer to FIGS. 4-6. FIG. 4 is a schematic diagram illustrating a touch display device according to a third preferred embodiment of the present invention. FIG. 5 is a top-view diagram illustrating a top touch electrode according to the third preferred embodiment of the present invention. FIG. 6 is a top-view diagram illustrating a top touch electrode according to another exemplary embodiment of the present invention. As shown in FIG. 4, the third preferred embodiment of the present invention provides a touch display device 201. The touch display device 201 includes a display panel 110, a touch panel 130, and a non-self-luminescent display panel 220. The difference between the touch display device 201 of this embodiment and the touch display device 101 of the first preferred embodiment is that the non-self-luminescent display panel 220 includes a second controlling unit 222T, a third electrode 223, and a display medium layer 224. By controlling an electrical condition between the third electrode 223 and the bottom touch electrode 135, the display medium layer 224 may generate a non-self-luminescent display effect such as a reflective display effect or a transmissive display effect, and the display medium layer 224 may become transparent for letting the display image from the display panel 110 pass through the display medium layer 224. In other words, the bottom touch electrode 135 may be employed in the touch panel 130 to generate the force sensing effect and be employed in the non-self-luminescent display panel 220 to control the display medium layer 224 with the third electrode 223. Therefore, the upper substrate and the fourth electrode described in the first preferred embodiment are not required and may be omitted in this embodiment. The touch display device 201 may accordingly become lighter and thinner, and the transmittance of the touch display device 201 may also be enhanced. Additionally, the cover substrate 116 of this embodiment has an upper surface 116A and a lower surface 116B facing the luminescent unit 112, and the second controlling unit 222T as well as the third electrode 223 are preferably disposed on the upper surface 116A of the cover substrate 116. Therefore, the array substrate described in the first preferred embodiment is not required and may be omitted in this embodiment. The touch display device 201 may accordingly become further lighter and thinner, and the transmittance of the touch display device 201 may also be enhanced.

In other words, the display panel 110 and the non-self-luminescent display panel 220 share the cover substrate 116 in this embodiment, and the cover substrate 116 is employed as an array substrate in the non-self-luminescent display panel 220. Additionally, the non-self-luminescent display panel 220 and the touch panel 130 share the lower touch substrate 134 and the bottom touch electrode 135. The lower touch substrate 134 is employed as an upper substrate in the non-self-luminescent display panel 220, and the bottom touch electrode 135 is employed as a fourth electrode (and may also be referred as a top electrode) in the non-self-luminescent display panel 220. It is worth noting that the touch panel 130 and the display panel 110 of this embodiment may be combined by a sealant material 229 disposed between the lower touch substrate 134 and the cover substrate 116, and the adhesive layer described in the first preferred embodiment may not be required in this embodiment. Apart from the non-self-luminescent 220 which does not require the upper substrate, the fourth electrode, and the array substrate described in the first preferred embodiment, the other components, allocations and material properties of this embodiment are similar to those of the first preferred embodiment detailed above and will not be redundantly described. It is worth noting that, as shown in FIG. 4 and FIG. 5, the top touch electrode 132 may be a single layer electrode with any shapes. For example, the top touch electrode 132 may include a plurality of triangle sensing electrodes disposed on the lower surface 131B of the upper touch substrate 131, and FIG. 4 may be referred as a cross-sectional view diagram taken along a cross-sectional line A-A′ in FIG. 5. Additionally, as shown in FIG. 6, in another exemplary embodiment of the present invention, the top touch electrode 132 may include a plurality of sensing electrodes disposed on the upper touch substrate 131, and the shape of the top touch electrode 132 may be further modified according to different design considerations.

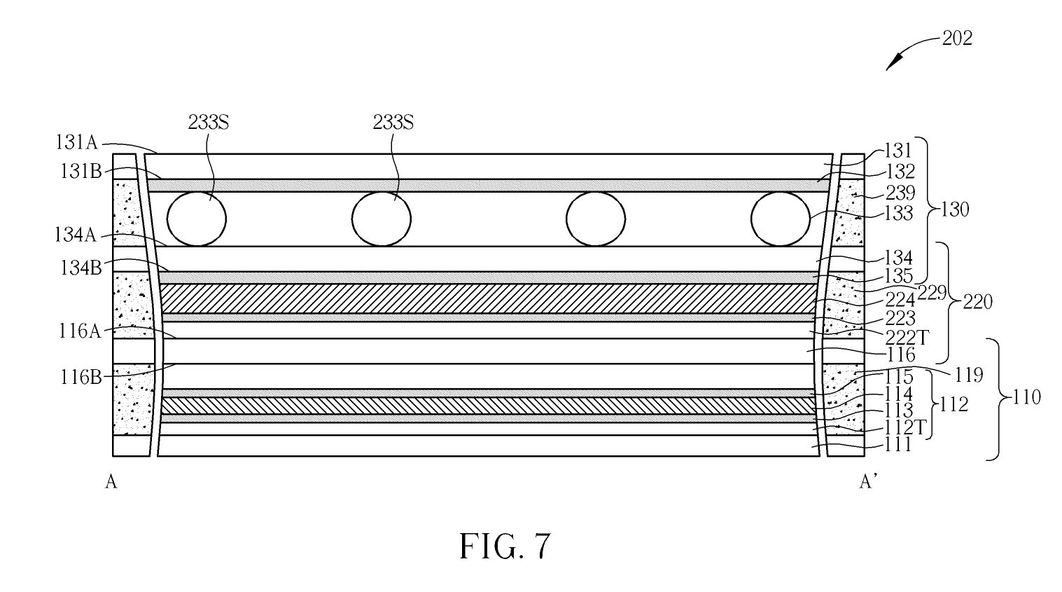

Please refer to FIG. 7. FIG. 7 is a schematic diagram illustrating a touch display device according to a fourth preferred embodiment of the present invention. As shown in FIG. 7, the difference between a touch display device 202 of this embodiment and the touch display device 201 of the third preferred embodiment is that the touch display device 202 further includes a plurality of spacers 233S disposed between the upper touch substrate 131 and the lower touch substrate 134, and the spacers 233S are employed to provide a function of supporting between the upper touch substrate 131 and the lower touch substrate 134. The spacers 233S may preferably include ball spacers or photo spacers, but not limited thereto. The ball spacers may preferably include inorganic material ball spacers or organic material ball spacers, and the photo spacers may preferably include acrylic material photo spacers, epoxy material photo spacers, or silicon photo spacers. It is worth noting that the spacers 233S are preferably employed with the spacing material layer 133, which is gaseous or liquid, but not limited thereto. In addition, when the spacing material layer 133, which is gaseous or liquid, is employed in the touch display device 201, the touch panel 130 may preferably include a sealant material 239 disposed between the upper touch substrate 131 and the lower touch substrate 134. The sealant material 239 may be employed to combine the upper touch substrate 131 and the lower touch substrate 134, and the spacing material layer 133 may be fixed between the upper touch substrate 131 and the lower touch substrate 134 by the sealant material 239. Apart from the spacers 233S and the sealant material 239 in this embodiment, the other components, allocations and material properties of this embodiment are similar to those of the third preferred embodiment detailed above and will not be redundantly described.

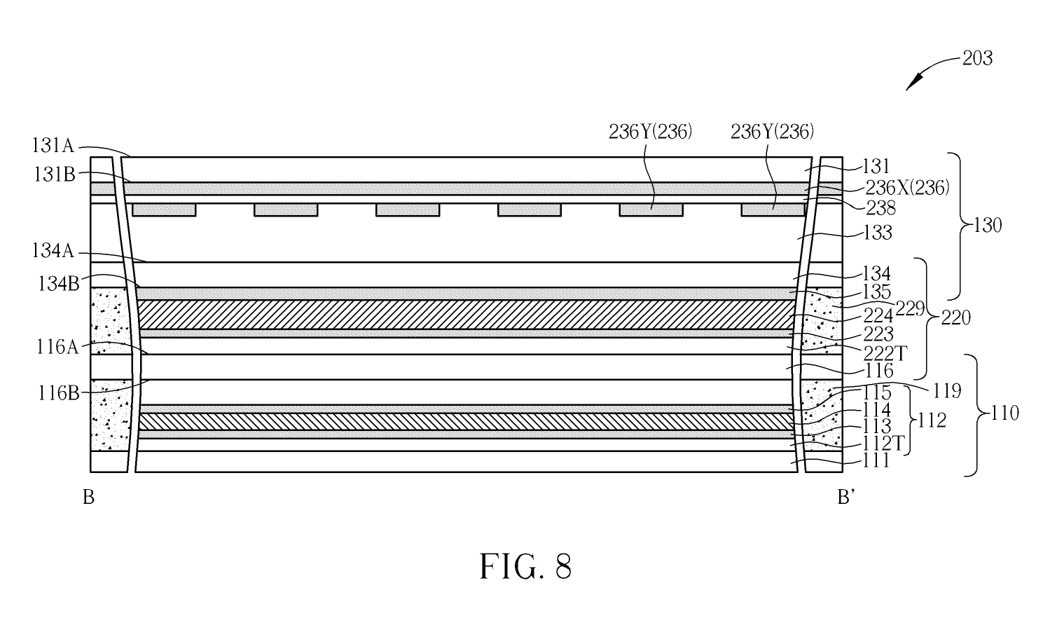

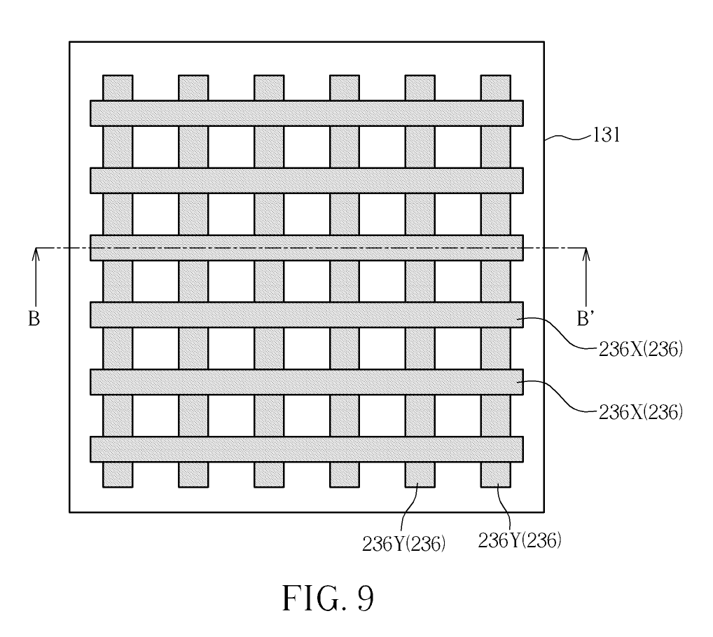

Please refer to FIG. 8 and FIG. 9. FIG. 8 is a schematic diagram illustrating a touch display device according to a fifth preferred embodiment of the present invention. FIG. 9 is a top-view diagram illustrating a top touch electrode according to the fifth preferred embodiment of the present invention. FIG. 8 may be referred as a cross-sectional view diagram taken along a cross-sectional line B-B′ in FIG. 9. As shown in FIG. 8 and FIG. 9, the difference between a touch display device 203 of this embodiment and the touch display device 201 of the third preferred embodiment is that the touch panel 130 in the touch display device 203 includes a top touch electrode 236, and the top touch electrode 236 includes a plurality of first axis sensing electrodes 236X and a plurality of second axis sensing electrodes 236Y. Each of the first axis sensing electrodes 236X and each of the second axis sensing electrodes 236Y are disposed interlacedly. The touch panel 130 may further include an insulating layer 238 disposed between the first axis sensing electrode 236X and the second axis sensing electrode 236Y. The insulating layer 238 is employed to isolate each of the first axis sensing electrodes 236X from each of the second axis sensing electrodes 236Y. In this embodiment, the first axis sensing electrode 236X and the second axis sensing electrode 236Y may respectively be a stripe transparent conductive pattern, but not limited thereto. Apart from the top touch electrode 236 and the insulating layer 238 in this embodiment, the other components, allocations and material properties of this embodiment are similar to those of the third preferred embodiment detailed above and will not be redundantly described. It is worth noting that a capacitive touch sensing effect may be generated by the first axis sensing electrodes 236X and the second axis sensing electrodes 236Y, which are disposed interlacedly, and the force sensing effect may be generated by the first axis sensing electrodes 236X, the second axis sensing electrodes 236Y, and the bottom touch electrode 135.

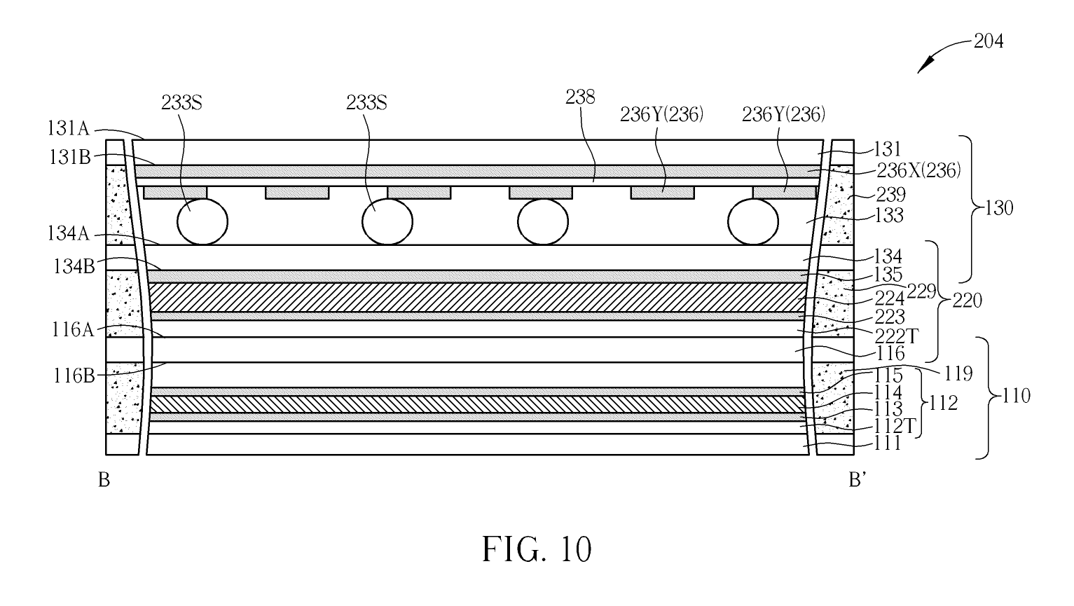

Please refer to FIG. 10. FIG. 10 is a schematic diagram illustrating a touch display device according to a sixth preferred embodiment of the present invention. As shown in FIG. 10, the difference between a touch display device 204 of this embodiment and the touch display device 203 of the fifth preferred embodiment is that the touch display device 204 further includes a plurality of spacers 233S disposed between the upper touch substrate 131 and the lower touch substrate 134, and the spacers 233S are employed to provide a function of supporting between the upper touch substrate 131 and the lower touch substrate 134. In addition, when the spacing material layer 133, which is gaseous or liquid, is employed in the touch display device 204, the touch panel 130 may preferably include a sealant material 239 disposed between the upper touch substrate 131 and the lower touch substrate 134. The sealant material 239 may be employed to combine the upper touch substrate 131 and the lower touch substrate 134, and the spacing material layer 133 may be fixed between the upper touch substrate 131 and the lower touch substrate 134 by the sealant material 239. Apart from the spacers 233S and the sealant material 239 in this embodiment, the other components, allocations and material properties of this embodiment are similar to those of the fifth preferred embodiment detailed above and will not be redundantly described.

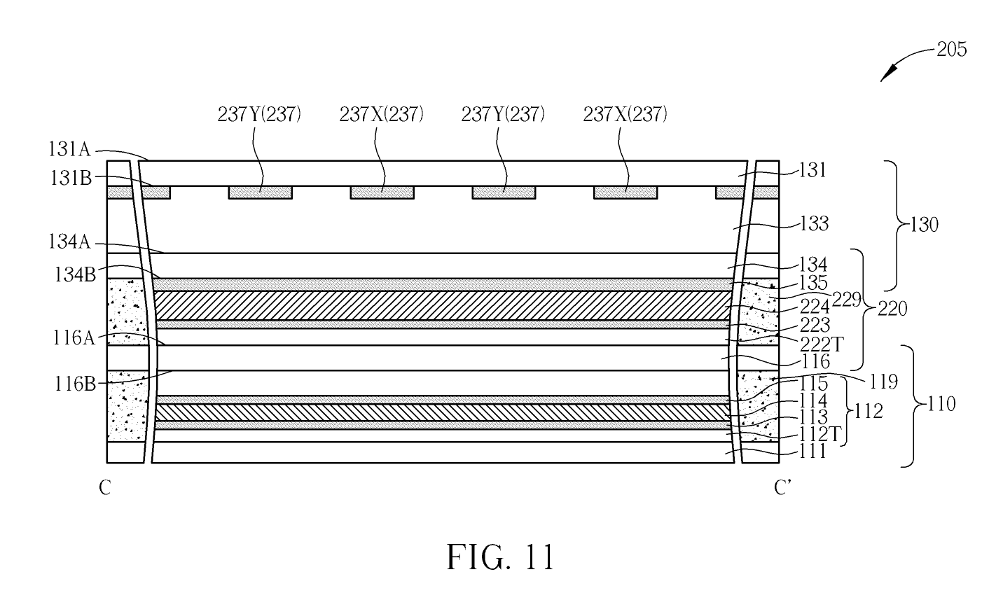

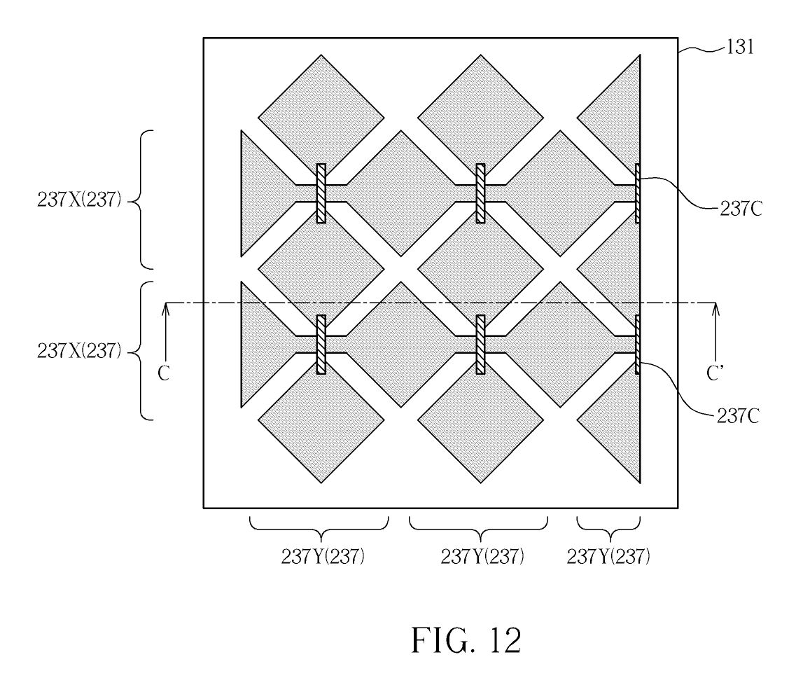

Please refer to FIG. 11 and FIG. 12. FIG. 11 is a schematic diagram illustrating a touch display device according to a seventh preferred embodiment of the present invention. FIG. 12 is a top-view diagram illustrating a top touch electrode according to the seventh preferred embodiment of the present invention. FIG. 11 may be referred as a cross-sectional view diagram taken along a cross-sectional line C-C′ in FIG. 12. As shown in FIG. 11 and FIG. 12, the difference between a touch display device 205 of this embodiment and the touch display device 203 of the fifth preferred embodiment is that the touch panel 130 of the touch display device 205 includes a top touch electrode 237, and the top touch electrode 237 includes a plurality of first axis sensing electrodes 237X and a plurality of second axis sensing electrodes 237Y. Each of the first axis sensing electrodes 237X and each of the second axis sensing electrodes 237Y are disposed on the lower surface 131B. Additionally, the touch panel 130 may further include at least one bridge 237C, which is employed to electrically connect two adjacent second axis sensing electrodes 237Y. The touch panel 130 may further include a passivation layer (not shown) at least partially covering each of the first axis sensing electrodes 237X and each of the second axis sensing electrodes 237Y in order to isolate the bridge 237C from the first axis sensing electrodes 237X. Apart from the top touch electrode 237 in this embodiment, the other components, allocations and material properties of this embodiment are similar to those of the fifth preferred embodiment detailed above and will not be redundantly described.

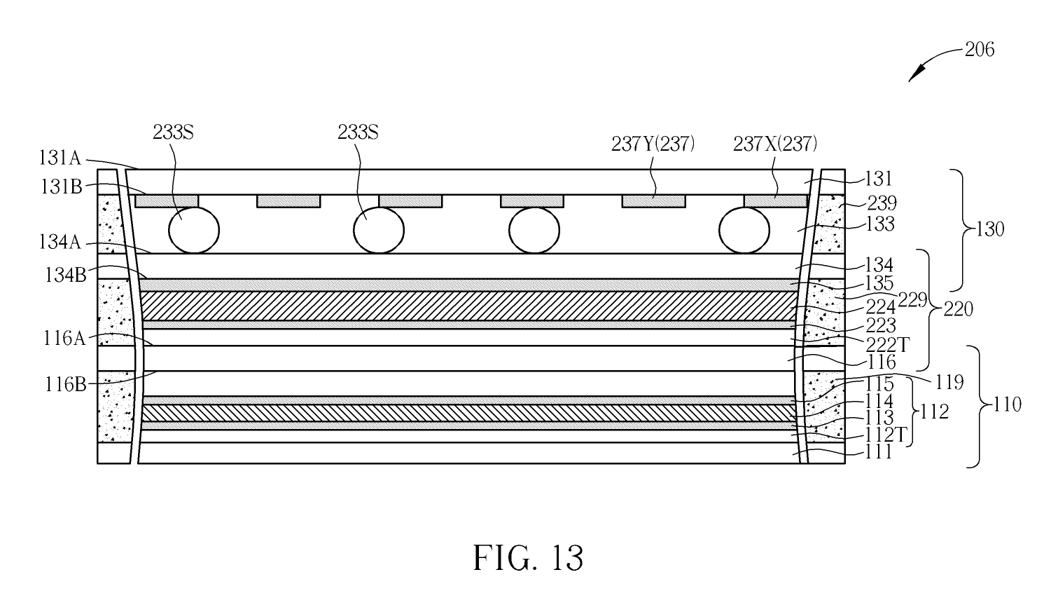

Please refer to FIG. 13. FIG. 13 is a schematic diagram illustrating a touch display device according to an eighth preferred embodiment of the present invention. As shown in FIG. 13, the difference between a touch display device 206 of this embodiment and the touch display device 205 of the seventh preferred embodiment is that the touch display device 206 further includes a plurality of spacers 233S disposed between the upper touch substrate 131 and the lower touch substrate 134, and the spacers 233S are employed to provide a function of supporting between the upper touch substrate 131 and the lower touch substrate 134. In addition, when the spacing material layer 133, which is gaseous or liquid, is employed in the touch display device 204, the touch panel 130 may preferably include a sealant material 239 disposed between the upper touch substrate 131 and the lower touch substrate 134. The sealant material 239 may be employed to combine the upper touch substrate 131 and the lower touch substrate 134, and the spacing material layer 133 may be fixed between the upper touch substrate 131 and the lower touch substrate 134 by the sealant material 239. Apart from the spacers 233S and the sealant material 239 in this embodiment, the other components, allocations and material properties of this embodiment are similar to those of the seventh preferred embodiment detailed above and will not be redundantly described.

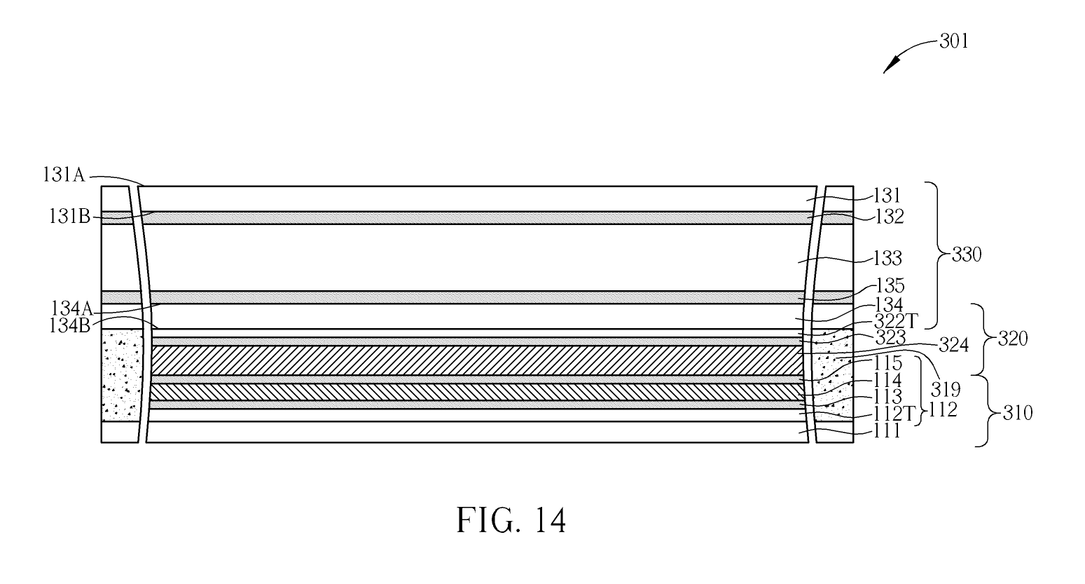

Please refer to FIG. 14. FIG. 14 is a schematic diagram illustrating a touch display device according to a ninth preferred embodiment of the present invention. As shown in FIG. 14, the ninth preferred embodiment of the present invention provides a touch display device 301. The touch display device 301 includes a display panel 310, a touch panel 330, and a non-self-luminescent display panel 320. The display panel 310 includes a luminescent unit 112, and the luminescent unit 112 includes a first controlling unit 112T, a first electrode 113, a light emitting layer 114, and a second electrode 115. The difference between the touch display device 301 of this embodiment and the touch display device 201 of the third preferred embodiment is that the non-self-luminescent 320 includes a second controlling unit 322T, a third electrode 323, and a display medium layer 324. The third electrode 323 and the second controlling unit 322T are disposed between the touch panel 330 and the display medium layer 324, and the second controlling unit 322T is electrically connected to the third electrode 323. In other words, the display medium layer 324 is disposed between the third electrode 323 and the second electrode 115 of the display panel 310. By controlling an electrical condition between the third electrode 323 and the second electrode 115, the display medium layer 324 may generate a non-self-luminescent display effect such as a reflective display effect or a transmissive display effect, and the display medium layer 324 may become transparent for letting the display image from the display panel 310 pass through the display medium layer 324. In other words, the second electrode 115 in this embodiment may be employed in the display panel 310 to drive the light emitting layer 114 with the first electrode 113 and be employed in the non-self-luminescent display panel 320 to control the display medium layer 324 with the third electrode 323. In this embodiment, the luminescent unit 112, the second controlling unit 322T, the third electrode 323, and the display medium layer 324 are disposed between the lower substrate 111 and the lower touch substrate 134. A dam 319 is employed to surround the luminescent unit 112, the second controlling unit 322T, the third electrode 323, and the display medium layer 324. Therefore, the cover substrate described in the third preferred embodiment is not required and may be omitted in this embodiment. The touch display device 301 may accordingly become lighter and thinner, and the transmittance of the touch display device 301 may also be enhanced. Apart from the second controlling unit 322T, the third electrode 323, the display medium layer 324, and the cover substrate, the other components, allocations and material properties of this embodiment are similar to those of the third preferred embodiment detailed above and will not be redundantly described. It is worth noting that the bottom touch electrode 135 of the touch panel 330 may be preferably disposed on the upper surface 134A of the lower touch substrate 134, and the bottom touch electrode 135 may not influence the second controlling unit 322T and the third electrode 323 disposed on the lower surface 134B of the lower touch substrate 134. Additionally, the touch panel 330 may be selectively driven by a resistance type or a capacitance type touch sensing method, and the resistance type or the capacitance type force sensing effect may then be formed in the touch panel 330.

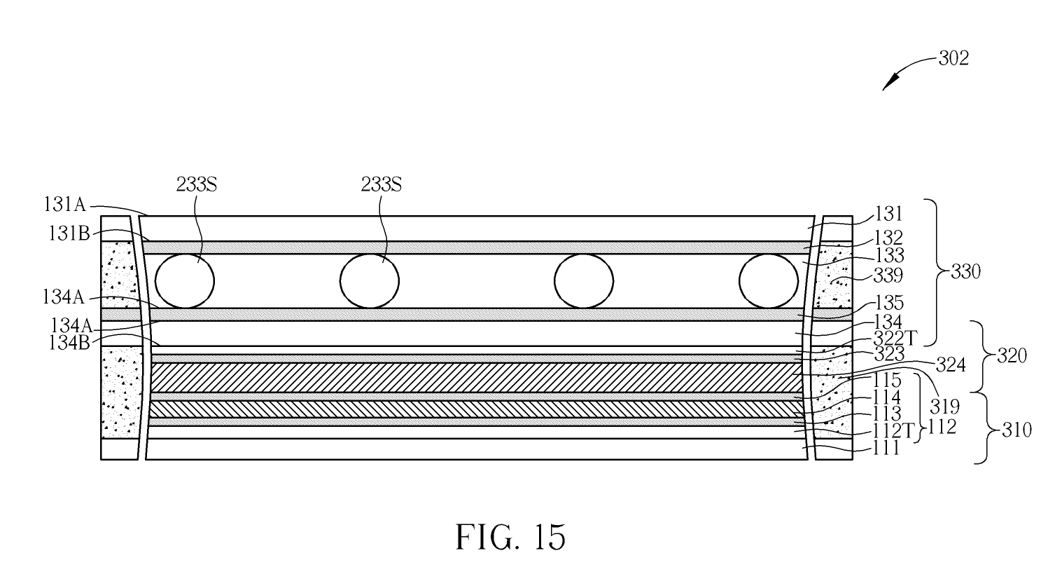

Please refer to FIG. 15. FIG. 15 is a schematic diagram illustrating a touch display device according to a tenth preferred embodiment of the present invention. As shown in FIG. 15, the difference between a touch display device 302 of this embodiment and the touch display device 301 of the ninth preferred embodiment is that the touch display device 302 further includes a plurality of spacers 233S disposed between the upper touch substrate 131 and the lower touch substrate 134, and the spacers 233S are employed to provide a function of supporting between the upper touch substrate 131 and the lower touch substrate 134. In addition, when the spacing material layer 133, which is gaseous or liquid, is employed in the touch display device 302, the touch panel 330 may preferably include a sealant material 339 disposed between the upper touch substrate 131 and the lower touch substrate 134. The sealant material 339 may be employed to combine the upper touch substrate 131 and the lower touch substrate 134, and the spacing material layer 133 may be fixed between the upper touch substrate 131 and the lower touch substrate 134 by the sealant material 339. Apart from the spacers 233S and the sealant material 339 in this embodiment, the other components, allocations and material properties of this embodiment are similar to those of the ninth preferred embodiment detailed above and will not be redundantly described.

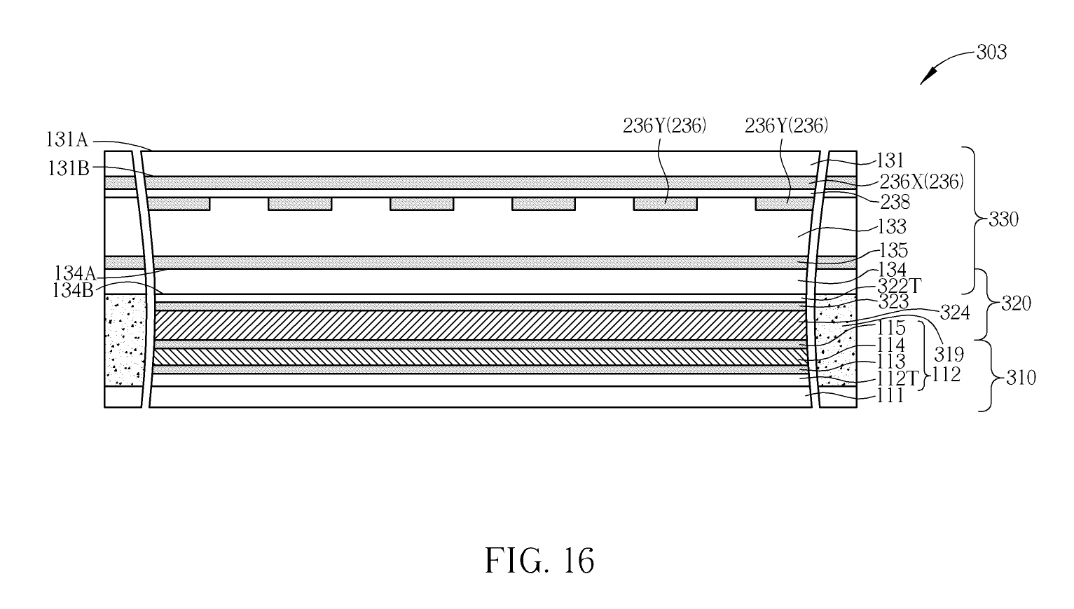

Please refer to FIG. 16. FIG. 16 is a schematic diagram illustrating a touch display device according to an eleventh preferred embodiment of the present invention. As shown in FIG. 16, the difference between a touch display device 303 of this embodiment and the touch display device 301 of the ninth preferred embodiment is that the touch panel 330 in the touch display device 303 includes a top touch electrode 236, and the top touch electrode 236 includes a plurality of first axis sensing electrodes 236X and a plurality of second axis sensing electrodes 236Y. The touch panel 330 may further include an insulating layer 238 disposed between the first axis sensing electrode 236X and the second axis sensing electrode 236Y. The insulating layer 238 is employed to isolate each of the first axis sensing electrodes 236X from each of the second axis sensing electrodes 236Y. The allocation of the first axis sensing electrode 236X and the second axis sensing electrode 236Y in this embodiment are similar to those of the fifth preferred embodiment detailed above. Apart from the top touch electrode 236 and the insulating layer 238 in this embodiment, the other components, allocations and material properties of this embodiment are similar to those of the ninth preferred embodiment detailed above and will not be redundantly described. It is worth noting that the touch display device 303 may also include a plurality of spacers (not shown) disposed between the upper touch substrate 131 and the lower touch substrate 134 in order to provide the function of supporting.

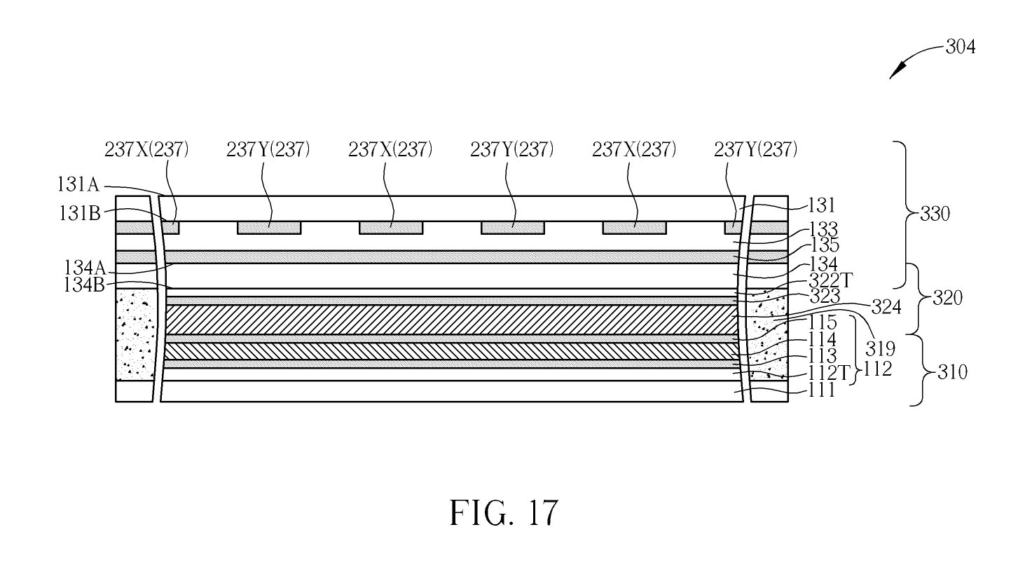

Please refer to FIG. 17. FIG. 17 is a schematic diagram illustrating a touch display device according to a twelfth preferred embodiment of the present invention. As shown in FIG. 17, the difference between a touch display device 304 of this embodiment and the touch display device 301 of the ninth preferred embodiment is that the touch panel 330 of the touch display device 304 includes a top touch electrode 237, and the top touch electrode 237 includes a plurality of first axis sensing electrodes 237X and a plurality of second axis sensing electrodes 237Y. Each of the first axis sensing electrodes 237X and each of the second axis sensing electrodes 237Y are disposed on the lower surface 131B of the upper touch substrate 131. The allocation of the first axis sensing electrode 237X and the second axis sensing electrode 237Y in this embodiment are similar to those of the seventh preferred embodiment detailed above. Apart from the top touch electrode 237 in this embodiment, the other components, allocations and material properties of this embodiment are similar to those of the ninth preferred embodiment detailed above and will not be redundantly described. It is worth noting that the touch display device 304 may also include a plurality of spacers (not shown) disposed between the upper touch substrate 131 and the lower touch substrate 134 in order to provide the function of supporting.

To summarize the above descriptions, in the present invention, the non-self-luminescent display device is disposed between the touch panel and the display panel. A normal display mode and a non-self-luminescent display may be switchable in the touch display device of the present invention, and the power consumption and the usability of the touch display device may be accordingly enhanced. Additionally, the touch panel, the non-self-luminescent display panel, and the display panel share some substrates in the touch display device of the present invention, and the purposes of lighter and thinner designs and improvement on the display quality may accordingly be achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device, comprising:
a display panel, comprising:
a lower substrate; and
at least one luminescent unit, disposed on the lower substrate, for generating a display image;
a touch panel, disposed correspondingly to the display panel; and
a non-self-luminescent display panel, disposed between the touch panel and the display panel, wherein the non-self-luminescent display panel comprises a display medium layer, for generating a non-self-luminescent display image or for being transparent to let the display image from the display panel pass through the display medium layer.

2. The touch display device of claim 1, wherein the luminescent unit comprises an organic light emitting diode unit.

3. The touch display device of claim 1, wherein the display medium layer comprises a cholesteric liquid crystal, a polymer dispersed liquid crystal (PDLC), a polymer network liquid crystal (PNLC), an electronic ink, or a quick response liquid powder.

4. The touch display device of claim 1, further comprising a first adhesive layer and a second adhesive layer, wherein the first adhesive layer is disposed between the display panel and the non-self-luminescent display panel to combine the display panel with the non-self-luminescent display panel, and the second adhesive layer is disposed between the non-self-luminescent display panel and the touch panel to combine the non-self-luminescent display panel with the touch panel.

5. The touch display device of claim 1, wherein the display panel further comprises a cover substrate disposed correspondingly to the lower substrate, the luminescent unit is disposed between the lower substrate and the cover substrate, and the luminescent unit comprises:
a first controlling unit;
a first electrode electrically connected to the first controlling unit;
a second electrode, disposed correspondingly to the first electrode; and
a light emitting layer, disposed between the first electrode and the second electrode.

6. The touch display device of claim 5, wherein the non-self-luminescent display panel further comprises a third electrode, disposed between the cover substrate and the display medium layer.

7. The touch display device of claim 6, wherein the non-self-luminescent display panel further comprises a second controlling unit disposed between the cover substrate and the display medium layer, and the second controlling unit is electrically connected to the third electrode.

8. The touch display device of claim 1, wherein the non-self-luminescent display panel further comprises a third electrode, disposed between the touch panel and the display medium layer.

9. The touch display device of claim 8, wherein the non-self-luminescent display panel further comprises a second controlling unit disposed between the touch panel and the display medium layer, and the second controlling unit is electrically connected to the third electrode.

10. The touch display device of claim 8, wherein the display medium layer is disposed between the third electrode and the luminescent unit, and the luminescent unit comprises:
a first controlling unit;
a first electrode electrically connected to the first controlling unit;
a second electrode, disposed correspondingly to the first electrode; and
a light emitting layer, disposed between the first electrode and the second electrode.

11. The touch display device of claim 1, wherein the touch panel includes a force sensing touch panel.

12. The touch display device of claim 1, wherein the touch panel comprises:
an upper touch substrate;
a lower touch substrate, disposed correspondingly to the upper touch substrate;
a top touch electrode, disposed between the upper touch substrate and the lower touch substrate;
a spacing material layer, disposed between the upper touch substrate and the lower touch substrate; and
a bottom touch electrode, disposed correspondingly to the top touch electrode.

13. The touch display device of claim 12, wherein the bottom touch electrode is disposed between the lower touch substrate and the spacing material layer.

14. The touch display device of claim 12, wherein the lower touch substrate is disposed between the bottom touch electrode and the spacing material layer.

15. The touch display device of claim 12, wherein the top touch electrode comprises at least one first axis sensing electrode and at least one second axis sensing electrode.

16. The touch display device of claim 15, wherein the touch panel further comprises an insulating layer, disposed between the first axis sensing electrode and the second axis sensing electrode.

17. The touch display device of claim 12, wherein the spacing material layer comprises a solid spacing material, a liquid spacing material, or a gaseous spacing material.

18. The touch display device of claim 12, wherein the upper touch substrate comprises a polarizer substrate.

19. The touch display device of claim 1, further comprising a polarizer disposed on the touch panel.

20. The touch display device of claim 19, wherein the display medium layer comprises a positive nematic liquid crystal or a negative nematic liquid crystal.
